(19) United States
(12) Patent Application Publication
(10) Pub. No.: US 2020/0226204 A1
(43) Pub. Date: Jul. 16, 2020

(54) SYSTEM AND METHOD FOR STATISTICALLY PREDICTING THE EXPECTED PERFORMANCE OF A SPORTING ENTITY

(71) Applicant: PlayLine LTD., York (CA)

(72) Inventors: Aaron Avruskin, Toronto (CA); Jason Falovitch, Toronto (CA)

(21) Appl. No.: 16/739,709

(22) Filed: Jan. 10, 2020

Related U.S. Application Data
(60) Provisional application No. 62/791,263, filed on Jan. 11, 2019.

(51) Int. Cl. G06F 17/18; G07F 17/32

(52) U.S. Cl. CPC G06F 17/18; G07F 17/3288

(57) ABSTRACT

Various embodiments are described herein for statistically predicting the expected performance of a sporting entity. In one example embodiment, a system is provided which comprises: at least one server comprising at least one processor and a non-transitory memory having stored thereon instructions that, upon execution, cause the processor to perform functions comprising determining a target performance metric in association with the sporting entity; determining at least one data category, and at least one data filter in association with each of the at least one data category; receiving data for each of the at least one data category, wherein the data received for each of the at least one data category is filtered according to the at least one data filter; based on the received data, generating at least one statistical feature for each of the at least one data category.

### REFERENCE TO RELATED APPLICATION

This application claims the benefit of U.S. Provisional Application No. 62/791,263 filed on Jan. 11, 2019, which is incorporated by reference herein in its entirety.

### FIELD

The described embodiments relate to statistical prediction models, and in particular to a system and method for statistically predicting the expected performance of a sporting entity.

### BACKGROUND

In recent years, statistical prediction models have found increased, wide-spread attention in forecasting the expected performance of athletes and sports teams. In one example application, games of skill—which allow users to place predictive bets on the outcome of sporting events—will rely on statistical prediction models (e.g., predictive betting models) to generate betting odds. In other example applications, statistical predictions models can also be used by professional athletes and sporting teams to improve future performance of athletes and teams, or alternatively, to predict future performance of opposing athletes and teams.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In accordance with one aspect of this disclosure, which may be used alone or in combination with any other aspect, there is provided a system for generating statistical predictions for an expected performance of a sporting entity, the system comprising: at least one server comprising at least one processor and a non-transitory memory having stored thereon instructions that, upon execution, cause the processor to perform functions comprising: determining a target performance metric in association with the sporting entity; determining at least one data category and at least one data filter in association with each of the at least one data category; receiving data for each of the at least one data category, wherein the data received for each of the at least one data category is filtered according to the at least one data filter; based on the received data, generating at least one statistical feature for each of the at least one data category, wherein the at least one statistical feature comprises a prediction of the expected performance of the sporting entity in respect of the target performance metric; and updating the non-transitory memory to include the at least one statistical feature for each of the at least one data category.

In some embodiments, the at least one data category comprises at least one of historical performance data for the sporting entity, recent performance data for the sporting entity, and global sporting entity performance data.

In some embodiments, the data filters comprise at least one of a time interval filter and at least one key performance indicator (KPI) filter.

In some embodiments, the at least one data category comprises a plurality of data categories, wherein each of the plurality of data categories is assigned a respective bias weight, and the processor further preforms the function of: generating a combined statistical data set by combining the at least one statistical feature generated for each of the plurality of data categories in accordance with the bias weights assigned to each of the plurality of data categories.

In some embodiments, the combined statistical data set comprises at least one of an average statistical value, a standard deviation, and a set of confidence rating ranges.

In some embodiments, the processor further preforms the function of: receiving an actual performance outcome for the target performance metric; based on the actual performance outcome, determining the accuracy of the combined statistical data set; and based on the determined accuracy of the combined statistical data set, modifying the bias weightings assigned to each of the plurality of data categories.

In some embodiments, the system further preforms the function of: generating a contest for predicting the actual performance outcome; and generating a predicted outcome based on the average statistical value determined in the combined statistical data set.

In some embodiments, the contest is a betting contest and a set of betting odds are generated based on the set of confidence rating ranges in the combined statistical data set.

In some embodiments, the processor further preforms the function of:

receiving at least one contest entry from at least one contestant, wherein each of the at least one contest entry comprises a predicted outcome for the contest; determining the difference between the actual performance outcome and the predicted outcome, for each of the at least one contest entry; and based on the difference, determining a payout, wherein the payout increases as the predicted outcome is more proximal to the actual performance outcome, and wherein the value of the payout is determined according to the set of betting odds.

In some embodiments, the contest comprises predicting a plurality of target performance metrics for at least one sporting entity, and the processor further preforms the function of: receiving at least one contest entry from at least one contestant, wherein each of the at least one contest entry comprises a set of predicted outcomes for the contest; based on the actual performance outcome, determining the number of correct predictions in the set of predicted outcomes for each of the at least one contest entry; and determining a payout for each of the at least one contestant, wherein the payout increases in proportion to the number of correct predictions in the set of predicted outcomes, and wherein the value of the payout is determined according to the set of betting odds.

In some embodiments, a bonus line is awarded as a payout in a case where each prediction, in the set of predicted outcomes, is correct.

In some embodiments, the contest is in respect of an outcome of a live sporting event.

In accordance with one aspect of this disclosure, which may be used alone or in combination with any other aspect, there is provided a method for generating statistical predictions for an expected performance of a sporting entity, the method being implemented by at least one server comprising least one processor and a non-transitory memory, the method comprising: determining a target performance metric in association with the sporting entity; determining at least one data category, and at least one data filter in association with each of the at least one data category; receiving data for each of the at least one data category, wherein the data received for each of the at least one data category is filtered according to the at least one data filter; based on the received data, generating at least one statistical feature for each of the at least one data category, wherein the at least one statistical feature comprises a prediction of the expected performance of the sporting entity in respect of the target performance metric; and updating the non-transitory memory to include the at least one statistical feature for the at least one data category.

In some embodiments, the at least one data category comprises at least one of: historical performance data for the sporting entity, recent performance data for the sporting entity, and global sporting entity performance data.

In some embodiments, the data filters comprise at least one of a time interval filter and at least one key performance indicator (KPI) filter.

In some embodiments, the at least one data category comprises a plurality of data categories, wherein each of the plurality of data categories is assigned a respective bias weight, and the method further comprises: generating a combined statistical data set by combining the at least one statistical feature generated for each of the plurality of data categories in accordance with the bias weights assigned to each of the plurality of data categories.

In some embodiments, the combined statistical data comprises at least one of an average statistical value, a standard deviation, and a set of confidence rating ranges.

In some embodiments, the method further comprises: receiving an actual performance outcome for the target performance metric; based on the actual performance outcome, determining the accuracy of the combined statistical data set; and based on the determined accuracy of the combined statistical data set, modifying the bias weightings assigned to each of the plurality of data categories.

In some embodiments, the method further comprises: generating a contest for predicting the actual performance outcome; and generating a predicted outcome based on the average statistical value determined in the combined statistical data set.

In some embodiments, the contest is a betting contest and a set of betting odds are generated based on the set of confidence rating ranges in the combined statistical data set.

In some embodiments, the method further comprises: receiving at least one contest entry from at least one contestant, wherein each of the at least one contest entry comprises a predicted outcome for the contest; determining the difference between the actual performance outcome and the predicted outcome, for each of the at least one contest entry; and based on the difference, determining a payout, wherein the payout increases as the predicted outcome is more proximal to the actual performance outcome, and wherein the value of the payout is determined according to the set of betting odds.

In some embodiments, the contest comprises predicting a plurality of target performance metrics for at least one sporting entity, and the method further comprises: receiving at least one contest entry from at least one contestant, wherein each of the at least one contest entry comprises a set of predicted outcomes for the contest; based on the actual performance outcome, determining the number of correct predictions in the set of predicted outcomes, for each of the at least one contest entry; and determining a payout for each of the at least one contestant, wherein the payout increases in proportion to the number of correct predictions in the set of predicted outcomes, and wherein the value of the payout is determined according to the set of betting odds.

In some embodiments, a bonus line is awarded as a payout where each prediction in the set of predicted outcomes is correct.

In some embodiments, the contest is in respect of an outcome of a live sporting event.

It will be appreciated by a person skilled in the art that a system or method disclosed herein may embody any one or more of the features contained herein and that the features may be used in any particular combination or sub-combination.

These and other aspects and features of various embodiments will be described in greater detail below.

### DRAWINGS

For a better understanding of the various embodiments described herein, and to show more clearly how these various embodiments may be carried into effect, reference will be made, by way of example, to the accompanying drawings which show at least one example embodiment and the figures will now be briefly described.

FIG. 1 illustrates a simplified block diagram of a computer network system in accordance with an example embodiments;

FIG. 2A illustrates a block diagram of an example server located in the computer network system of FIG. 1, in accordance with an example embodiment;

FIG. 2B illustrates a block diagram of an example user device located in the computer network system of FIG. 1, in accordance with an example embodiment;

FIG. 3 illustrates an example process flow for a method for predicting the expected performance of a sporting entity based on a statistical prediction model; and

FIG. 4 is an example process flow for a method for determining payout in an example betting contest using a progressive payout scheme.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EXAMPLE EMBODIMENTS

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

A software application may have a plurality of different configurations that may be used for the application user interface. The different configurations may be designed to encourage user engagement with the application and/or to facilitate user interactions. Different configurations may include variations of user interface elements and user interface parameters that may facilitate user interactions by different users. Modifying the configuration of a software application to be more tailored to individual users can increase user engagement and facilitate user interactions with a software application.

As stated in the background, statistical prediction models have found increased, wide-spread attention in recent years for forecasting the expected performance of sporting entities. As used herein, a sporting entity may refer, inter alia, to an athlete, a player, a group of athletes or players, or to a sporting team. In one example application, games of skill—which permit users to place predictive bets on the outcome of sporting events—may rely on statistical prediction models (e.g., predictive betting models) to generate betting odds. Statistical models have also been used by professional athletes or professional sporting teams to improve future performance, or alternatively, to predict the future performance of opposing athletes and teams.

The use of statistical prediction models in sports has not, however, found prevalent application for predicting, in real-time or near real-time, the expected performance of athletes and teams during live sporting events (e.g., predicting the outcome of in-game sports events). Further, statistical prediction models have not always accurately accounted for all factors which bear on the future performance of sporting entities so as to generate accurate predictions of future performance.

In view of the foregoing, and in accordance with various teachings provided herein, there is provided a system and method for statistically predicting the expected performance of a sporting entity.

In at least some embodiments, the system and method may generate predictions, in real time or near real-time, for the outcomes of in-game events occurring during live sporting matches. In at least one example application, the statistical predictions may be used for generating contests which allow users to predict the outcome of live events. In another example application, the statistical predictions may be used for generating betting odds in contests which allow users to place live predictive bets.

In various embodiments, statistical predictions for the expected performance of a target sporting entity may be generated by analyzing data in one or more pre-determined data categories. The data categories may include historical data performance, as well as recent data performance for the target sporting entity. In other embodiments, the data categories may also include historical data performance for all sporting entities which are involved in the same sport. In still other embodiments, the data categories may include other relevant external data including, for example, statistical odds generated by external bookmakers.

In various cases, the data analyzed in each data category may be filtered according to one or more pre-defined data filters to include only a sub-set of relevant data. For example, as explained herein, the data may be filtered according to one or more key performance indicators (KPI). The KPI filters may be determined in view of the target performance metric which is being statistically predicted, and the specific target sporting entity.

In various embodiments, the filtered data in each data category may be analyzed to determine one or more statistical features (e.g., average values, standard deviation values, and confidence ranges). The statistical features generated in each data category may be combined to generate a combined set of statistical data. In at least some embodiments, the statistical features may be combined by allocating a pre-defined bias weight to each data category. The bias weights may be determined and modified using a machine learning algorithm configured for supervisory learning.

In at least one example application, the data contained in the combined statistical data set may be used for generating betting odds in a game of skill (e.g., a contest) which allows users to place predictive bets on the outcome of either future sporting events, or live in-game events. In at least some embodiments, a progressive payout scheme may be used for rewarding betting users based on the proximity of their bet to the actual outcome, or the number of correct predictions the user has made in a set of predictive bets.

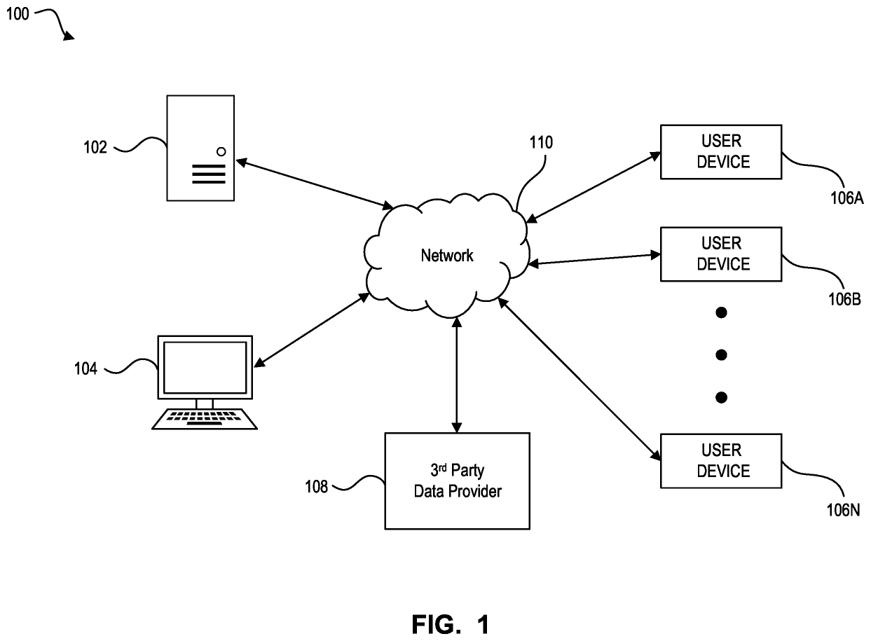

Referring now to FIG. 1, there is shown a block diagram of a computer network system 100 in accordance with an example embodiment. As shown, the computer network system 100 generally includes a server 102, an administrator computer 104, and a plurality of user devices 106A-106N connected via network 110. In at least some embodiments, the network system 100 may also include one or more third party data providers 108.

Network 110 may be connected to the internet. Typically, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Server 102 is a computer server that is connected to network 110. Server 102 has a processor, volatile and non-volatile memory, at least one network interface, and may have various other input/output devices. As with all devices shown in the system 100, there may be multiple servers 102, although not all are shown.

User devices 106 generally refer to desktop or laptop computers, but may also refer to smartphones, tablet computers, as well as a wide variety of “smart” devices capable of data communication. Like server 102, user devices 106 each include a processor, a volatile and non-volatile memory, at least one network interface, and input/output devices. User devices 106 may be portable, and may at times be connected to network 110 or a portion thereof.

Third party data provider 108 may be any suitable external source of data which is configured to provide data in respect of past or future sporting events. In at least some embodiments, data provider 108 may also be configured to provide data in real time, or near real-time, for on-going or live sporting events.

The data provided by data provider 108 may include all forms of data that are generated during the course of a sporting event, or are otherwise relevant to past, future or live sporting events. For example, data provider 108 can provide data relating to the outcome of a sporting event, or otherwise, to the performance of specific players, athletes or teams involved in a sporting event (e.g., player or team statistics). Data provider 108 can also be configured to provide scheduling information, such as weekly or seasonal schedules for upcoming sporting matches, as well as past scheduling information. As explained in further detail herein, the type of data provided by data provider 108 may vary based on the sporting event (e.g., golf, basketball, or tennis).

In at least some embodiments, data provider 108 may only transmit data in response to a data request, e.g., from server 102 and/or user devices 106. The data requests may, for example, request certain sets or types of data in respect of certain sporting events. In other cases, data provider 108 may automatically “push” data, e.g., to server 102 and/or user devices 106, without waiting for a request. For example, data provider 108 can automatically provide a “live stream” of data upon establishing a connection with server 102 and/or user devices 106.

While FIG. 1 illustrates only a single data provider 108, it will be appreciated that network system 100 may, in other cases, include a plurality of data providers 108. For instance, different data providers 108 may be available for producing data in respect of different sports, or different sporting events. In other cases, different data providers 108 may also be available to provide data in relation to the same sporting event.

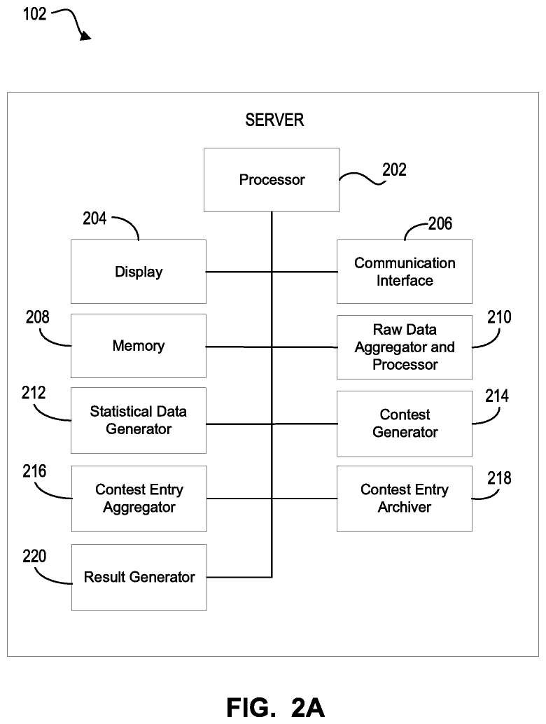

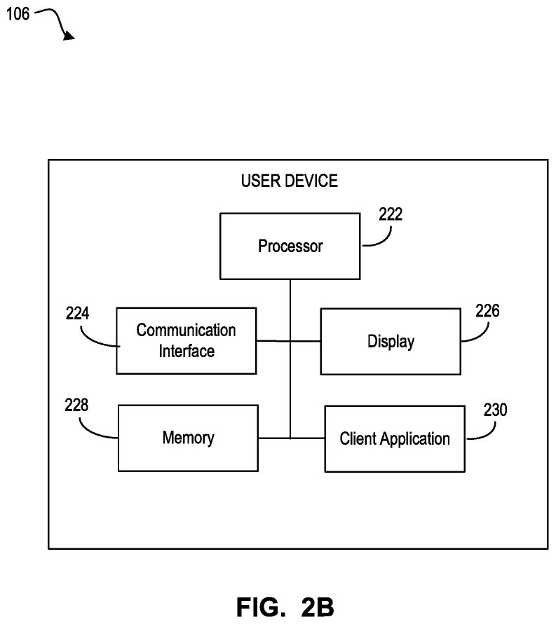

Referring now to FIG. 2A, there is shown a simplified block diagram of the server 102, in accordance with an example embodiment.

As shown in FIG. 1, server 102 is a computer server that is connected to network 110. As shown in FIG. 2A, server 102 can include a processor 202, a display 204, a communication interface 206, and a memory 208. Server 102 can also include a raw data aggregator and processor program 210, a statistical data generator program 212, a contest generator program 214, a contest entry aggregator 216, a contest entry archiver program 218, and a result generator program 220. Although shown as separate elements, it will be understood that the programs 210-220 may be stored in memory 208.

It will be also be further understood that the server 102 need not be a dedicated physical computer for executing each of the programs 210-216. For example, in various embodiments, the various logical components that are shown as being provided on server 102 may be hosted by a third party “cloud” hosting service such as Amazon™ Web Services™ Elastic Compute Cloud (Amazon EC2).

Processor 202 is a computer processor, such as a general purpose microprocessor. In some other cases, processor 202 may be a field programmable gate array, application specific integrated circuit, microcontroller, or other suitable computer processor.

Processor 202 is also coupled to display 204, which is a suitable display for outputting information and data as needed by various computer programs. In particular, display 204 may display a graphical user interface (GUI). In some cases, the display 204 may be omitted from server 102, for instance where the server 102 is configured to operate autonomously.

Communication interface 206 is one or more data network interface, such as an IEEE 802.3 or IEEE 802.11 interface, for communication over a network.

Processor 202 is coupled, via a computer data bus, to memory 208. Memory 208 may include both volatile and non-volatile memory. Non-volatile memory stores computer programs consisting of computer-executable instructions, which may be loaded into volatile memory for execution by processor 202 as needed. It will be understood by those of skill in the art that references herein to server 102 as carrying out a function or acting in a particular way imply that processor 202 is executing instructions (e.g., a software program) stored in memory 208 and possibly transmitting or receiving inputs and outputs via one or more interface. Memory 208 may also store data input to, or output from, processor 202 in the course of executing the computer-executable instructions. As noted above, memory 208 may also store programs 210-220.

Raw data aggregator and processor (RDAP) 210 may be configured to monitor, or request, data from one or more third party data providers 108. For example, in various cases, RDAP 210 may request or receive data in respect of: (a) past sporting events (e.g., outcomes, points scored, player or athlete statistics); (b) live or on-going sporting events (e.g., in-game events, live scores); or (c) future sporting events (e.g., game match schedules, team rosters for upcoming games).

In various cases, RDAP 210 may receive data from one or more third party data providers 108 by transmitting requests for data (e.g., using API calls), via communication interface 206, to a relevant data provider 108. In at least some embodiments, where the RDAP 210 is requesting data for a live, or on-going sporting event, RDAP 210 may be configured to transmit requests at pre-determined time intervals (e.g., every 5 minutes), or at pre-determined frequencies. In at least some cases, the time interval or frequency for sending data requests may be determined by the operator of remote terminal 104, and transmitted to the server 102 via network 110.

In at least some embodiments, the RDAP 210 may be configured to request data from a data provider 108 where the RDAP 210 determines that a live or on-going sporting event is occurring. For instance, the RDAP 210 can determine that a sporting event is occurring based on a schedule of upcoming sporting matches (e.g., a seasonal schedule) stored on memory 208. In some cases, the schedule may have been received from a data provider 108, in response to a previous data request from RDAP 210. In some cases, the schedule may also be updated through periodic requests from the RDAP 210 to the data provider 108, requesting an updated schedule. By receiving updated schedules, the RDAP 210 may account for sporting events which are cancelled or postponed. In other cases, the schedule may be automatically transmitted to the RDAP 210 from an operator of remote terminal 104. The RDAP 210 may periodically receive (or request) updated schedules from the operator of remote terminal 104. In particular, based on the schedule of sporting matches, the RDAP 210 may determine that a sporting event is on-going, and accordingly, the RDAP 210 can commence data requests from a relevant data provider 108 for data related to the live sporting event.

In other embodiments, the RDAP 210 may not transmit data requests in order to receive data from data provider 108, but rather, may automatically receive a live feed of data which is “pushed” or otherwise transmitted to the RDAP 210 from one or more data providers 108 in relation to a sporting event. Accordingly, in these cases, the RDAP 210 may be configured to “listen” to an incoming stream of data when it is determined that a sporting event is on-going.

In at least some embodiments, the type of data requested by the RDAP 210 from a data provider 108 may depend on the nature of the sporting event. For example, RDAP 210 may be configured to request different data for a game of basketball (e.g., player rebound data and player usage percent data), which may differ from a game of baseball (e.g., player batter performance). In various cases, the RDAP 210 may determine the nature of the sporting event based on information available in a sporting event schedule which is available to the RDAP 210 on memory 208. Accordingly, based on the nature of the sporting event, the RDAP 210 may request the types of data that are relevant to that sporting event. In other cases, which are explained in further detail herein, the type of data requested by RDAP 210 may be determined based on the requirements of the statistical data generator 214 and/or the contest generator 214.

RDAP 210 may also be configured to process (or convert) data received from one or more data providers 108, into a standardized data format. The standardized data format is stored, for example, in memory 208, and is made accessible to programs on server 102 (e.g., statistical data generator 214, contest generator 214, and/or the result generator 220). In at least some embodiments, RDAP 210 converts data into a standardized format by first identifying the data provider 108 which is transmitting the raw data. Based on this information, the RDAP 210 can identify a format of “raw” data which is typically transmitted by that data provider 108. In other words, the RDAP 210 can recognize that specific data providers 108 typically transmit data in specific raw formats (e.g., based on information previously stored in memory 208 in relation to each data provider 108, or data detected in the data stream from the data provider 108). The RDAP 210 may then convert the known raw data format into a standardized format. In some cases, the RDAP 210 converts the raw data format into a standardized format using different executable codes, pre-stored on memory 208, which are configured to effect the conversion of different raw data formats into the standardized data format. Where a plurality of data providers 108 is provided, the RDAP 210 is able to convert each raw data format, received from each data provider, into a single standardized format. In various cases, RDAP 210 may be configured to convert raw data into a standard format instantaneously, or near-instantaneously, in order to allow the standardized data format to be immediately available to other programs in server 102, e.g., during live sporting events.

Statistical data generator (SDG) 212 generates statistical predictions for the performance of specific sporting entities. As used herein, the performance of a sporting entity may refer to any performance metric which is relevant to that sporting entity. For example, a performance metric may relate to the probability that a team or athlete may win or lose a game, or the expected points a player or team may score in a forthcoming sports match or game season. The performance metric may vary based on the sporting event. For instance, the performance metrics in games of basketball may specifically relate to the expected rebounds for a specific basketball player, or a specific basketball player's expected usage time.

In various embodiments provided herein, SDG 212 may generate statistical predictions for in-game events during live sporting matches. For example, during a live face-off, the SDG 212 may predict, in real-time or near real-time, the likelihood that a hockey player will win possession in the live face-off event.

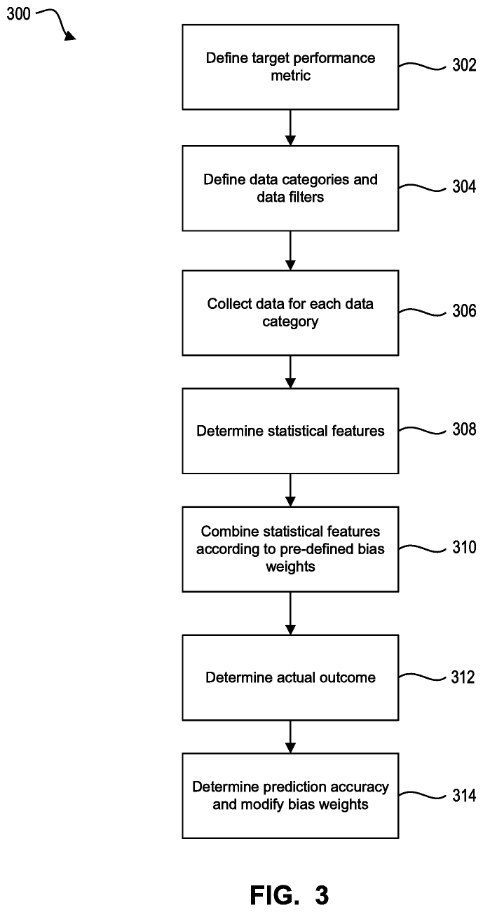

Referring now to FIG. 3, there is shown an example process flow for a method 300 for generating statistical predictions for the expected performance of a sporting entity, using the SDG 212. The method 300 may be implemented by the processor 202 of the server 102.

At 302, the target performance metric—which is the subject of statistical prediction—is defined. As explained in further detail herein, the target performance metric may be determined by the contest generator 214. For example, the contest generator 214 may generate a contest (e.g., a betting contest) which allows users to predict the expected performance for a particular athlete. In other cases, the target performance metric may be a metric which is transmitted by an operator of remote terminal 104, via network 110, to server 102. For example, the operator of remote terminal 104 may request a prediction, from server 102, for a particular performance metric.

At 304, data categories—associated with the performance metric—are defined. In various cases, the data categories may include: (a) a sporting entity's “historical performance data”, and (b) the sporting entity's “recent performance data”. In particular, recent performance data is used to account for sudden changes in a sporting entity's performance (e.g., resulting from player injuries), which may not otherwise be captured through historical performance data. In cases where the target performance metric relates to a particular athlete's performance, data categories can also include historical performance data for all players, or athletes, involved in the same sport as the target athlete (herein after referred to as “global athlete historical data”, or “global athlete data”). In particular, global athlete historical data can be used to refine the prediction accuracy for a specific athlete's performance.

In still other embodiments, the data categories may also include an external data category. External data may include statistics from external sources, and may be used to account for external factors which bear on a sporting entity's performance. For instance, external data can include the performance of opposing teams. For example, where the performance metric is related to the number of points a player is expected to score, the external data may include the opponent team's historical points per game (PPG) allowed, or the opponent's defense efficiency rating. Accordingly, the “external data” is data which may not necessarily be directly inferable from the sporting entity's historical performance data and recent performance data. External data can also include other external information, including odds generated by third party bookmakers for an upcoming sporting events, such as a Las Vegas over/under game total, and team's implied total. In various cases, one of the data providers 108 may be a third party bookmaker.

In order to limit the data analyzed within each data category, one or more data filters can be defined. For example, the data filters can include a “time interval filter”, which is used to limit the time frame of data analyzed in each data category. For instance, a “time filter” can limit data analyzed for “athlete historical performance data” to only data generated over a past game season. A “time filter” can also more specifically limit “athlete recent performance data” to data analyzed to a most recent three games.

In addition, or in the alternative, to using a “time interval filter”, data filters can also include key performance indicators (KPI). KPIs limit the analyzed data to data tied to a specific target performance metric. For example, KPI filters may filter data to include only games where an athlete has played a pre-determined number of minutes, or has a pre-determined percentage of usage time (e.g., in a game of basketball). Accordingly, KPI filters provide conditions for the data which is analyzed. The KPI filters may be selected, and may be varied, based on the nature of the sporting entity (e.g., different KPI filters may be selected for different athletes and different sports).

In some cases, data categories and data filters may be automatically selected by the SDG 212, based on the nature of the sporting event. In other cases, the SDG 212 may receive instructions from remote terminal 104, in respect of data categories and data filters. In still other embodiments, which are explained in further detail herein, the SDG 212 may determine the appropriate data categories and data filters based on the specific nature of contests generated by the contest generator 214.

At act 306, filtered data is collected for each data category defined in act 304.

In some cases, at act 306, filtered data is collected by scraping a repository of data stored (e.g., archived) in memory 208 of server 102. For example, memory 208 may store game data and stat data for previous games. This data may have been, for example, previously collected by the RDAP 210 from one or more data providers 108. In other cases, data is collected (e.g., scraped) using the RDAP 210. In particular, RDAP 210 can send specific data requests—in respect of each data category and data filter—to one or more relevant data providers 108.

Tables 1-4, below, show example data that can be collected at act 306. In the example cases below, the target performance metric is the predicted number of points a basketball player is expected to score in a forthcoming basketball event. The data is collected in respect of four different data categories: (a) athlete historical performance data; (b) athlete recent performance data; (c) global athlete performance data; and (d) external data.

TABLE 1
Athlete Historical Performance Data
Data Category 1 - Athlete Historical Performance Data

| | Time Interval Filter | | |
|---|---|---|---|
| | 2018-2019 Season | | |
| | KPI Filters | | |
| | | | Average Standard |
| | | Usage Rating | Deviation for Points |
| | Minutes Played Per | (Top 100) | Scored Per Season |
| | Game | (≤25 Min) | (≥6) |
| Eligible | 15 | 14 | 12 |
| Game | | | |
| Logs | | | |

TABLE 2
Athlete Recent Performance Data
Data Category 2 - Athlete Recent Performance Data

| | Time Interval Filter | | |
|---|---|---|---|
| | Last three (3) games | | |
| | KPI Filters | | |
| | | | Average Standard |
| | Minutes Played Per | | Deviation for Points |
| | Game | Usage Rating | Scored Per Season |
| | (≤25 Min) | (Top 100) | (≥6) |
| Eligible | 3 | 3 | 3 |
| Game | | | |
| Logs | | | |

TABLE 3
Global Athlete Historical Data
Data Category 3 - Global Athlete Historical Data

| | Time Interval Filter | | | | |
|---|---|---|---|---|---|
| | 2010-2017 | | | | |
| | KPI Filters | | | | |
| | Average | | | | Average |
| | Minutes | | | Average | Standard |
| | Played Per | | Minimum | Points | Deviation for |
| | Game Per | Usage | Games Played | Scored Per | Points Scored |
| | Season | Rating | Per Season | Season | Per Season |
| | (≤25 Min) | (Top 100) | (≤20) | (≤24) | (≥6) |
| Eligible | 137,645 | 61,383 | 58,928 | 20,323 | 17,432 |
| Game | | | | | |
| Logs | | | | | |

TABLE 4
Global Athlete Historical Data
Data Category 4 - External Data

| | Time Interval Filter | | | | |
|---|---|---|---|---|---|
| | Current Season | | | Upcoming Game | |
| | KPI Filters | | | | |
| | Opponent | Opponents | | Las Vegas Betting Line | |
| | Points Per | Defense | Average | Las Vegas | |
| | Game | Efficiency | Player Percent | Over/Under (O/U) | Player Team |
| | (PPG) | (ODE) Rating | Points Scored | Game Total | Implied Total |
| Data | 112 | 1.06 | 27.20% | 228 | 116 |

Table 1 shows data filters applied to the historical performance of the target athlete. In this example, a time interval filter is applied to limit data to games played by the target athlete in a previous game season. KPI filters are also applied to limit data to games where the athlete has played less than or equal to 25 minutes per game, has a usage rating within the top one hundred athletes, and has an average standard deviation of points scored per seasons of equal to, or greater than, six. The final row in Table 1 shows the number of eligible games which satisfy the applied filters. Accordingly, the eligible games may be analyzed to determine the athlete's historical performance in respect of the target performance metric (e.g., each eligible game is analyzed to determine the number of points scored by the athlete).

Table 2 shows data filters applied to the athlete's recent performance data. In this case, a time interval filter limits data analyzed to data generated in a most recent three games played by the target athlete. The KPI filters applied in Table 2 are similar to those applied in Table 1.

Table 3 shows data filters applied to global athlete historical data. The time interval filter is selected to include data within a seven year time frame. Further, KPIs filters are selected to only include game logs for athletes who have played an average of at least 25 games per season. In general, the KPI filters for the global historical data category are selected to be similar to the KPI filters used for the athlete's historical and recent data categories. This allows consideration of data generated by other athletes who exhibit similar performance statistics as the target athlete. In this manner, the global historical data category is used to enhance the predictive accuracy of the SDG 212.

Table 4 shows the external data category, which may include other data which may also bear on the athlete's expected performance. In this example case, the external data includes an opposing team's points per game (PPG) allowed, opposing team's defense efficiency (ODE) ratio in the current game season, as well as the average player points scored per game (APPSG) (e.g., expressed as a percent of the total points scored by the athlete's team in games played over a current season). In various cases, information and odds available from a Las Vegas betting line (or any other suitable bookmaker) may be also considered. For example, as shown in Table 4, the Las Vegas betting line data may include an over/under (O/U) game total, and a player team implied total. In still other cases, the external data may also include information regarding injuries recently sustained by the athlete, or injuries sustained by key players in the athlete's team or the opposing team (e.g., key defensive or offensive players whose performance may bear on the performance of the target athlete). The external data may also include team roster information in respect of the athlete's team or an opposing team (e.g., whether key players who affect the performance of the athlete are included or excluded from the roster). In some cases, player injury and roster data may be reflected in data generated by the external bookmaker.

At 308, the filtered data, collected at 306, is analyzed to determine one or more statistical features. Table 5, below, provides example statistical features which are generated using the data available in Tables 1-4. As shown, example statistical features which can be generated include: (a) average points scored per game for the target athlete (e.g., based on analyzing eligible game logs); (b) standard deviation; and (c) an “exact” confidence rating. As explained herein, the exact “confidence rating” may represent the predictive accuracy of the “average value”. For example, under “athlete historical performance data”, the average points scored per game is determined to be 28.8, and the exact confidence rating is 5.80%. Accordingly, this may indicate a 5.80% probability that the athlete will score 28.8 points in a forthcoming game, based only on the athlete's historical performance data. In various cases, the exact confidence rating is generated using the standard of deviation. For example, under “athlete historical performance data”, the exact confidence rating can be generated by multiplying the standard of deviation by two, converting the multiple product into a percentage (e.g., (1/(2*standard of deviation))*100), and adding/subtracting a margin of error from the generated percentage, to arrive at an exact confidence rating of 5.80%. A similar method can be used to generate the exact confidence ratings in each of the remaining data categories, using appropriate error margins.

TABLE 5
Statistical Features Generated for Each Data Category

| | Athlete | | | |
|---|---|---|---|---|
| | Historical | Athlete Recent | Global | |
| | Performance | Performance | Historical | External |
| | Data | Data | Data | Data |
| Average | 28.8 | 29.4 | 25.6 | 30.5 |
| Points Scored | | | | |
| Per Game | | | | |
| Standard | 5.6 | 3.6 | 4.8 | 7.1 |
| Deviation | | | | |
| Confidence | 5.80% | 15.90% | 6.60% | 13.90% |
| Rating (Exact) | | | | |

In at least one example case, in Table 5, the external data statistics may be generated as follows: (1) first, games which satisfy pre-determined external data filters are considered (e.g., games where the athlete has faced opponents with a pre-determined PPG and ODE), and used to generate a set of filtered data; (2) using the filtered data, a first statistical data set is generated (e.g., average points, standard deviation, and exact confidence rating); (3) to accommodate for factors which may not be captured considering only the filtered data (e.g., player injuries in the athlete's team or opposing team, which may affect the athlete's performance), the external data can also include data from an external bookmaker (e.g., over/under values), as well as average player points scored per game (APPSG) and player implied total values. In some cases, the athlete's game logs are evaluated to determine the extent to which the athlete's score has deviated from the APPSG. In some cases, a ±10% filter is applied to determine the likelihood the athlete's score will deviate within a range of 10% from the AAPSG. The various statistics (e.g., over/under, implied total values, etc.) are used to generate a second set of data; (4) A second set of statistical data is then generated based on the second data set (e.g., standard deviation, confidence ratings, etc.); and (5) the first and second sets of statistical data are then combined to generate the statistical data expressed in Table 5 under the external data category. For example, the statistical data can be combined using a weighted combination.

Table 6, below, provides further statistical features which are generated using data in Tables 1-5. In particular, Table 6 provides confidence rating “ranges”, which express the probability that the actual performance outcome will deviate from the average value determined in Table 5. In various cases, the confidence ranges may be determined using the standard deviation value, exact confidence range, and a margin of error.

TABLE 6
Confidence Rating Ranges for each Data Category

| | Athlete | | | |
|---|---|---|---|---|
| Confidence | Historical | Athlete Recent | Global Athlete | |
| Rating | Performance | Performance | Historical | External |
| (Range) | Data | Data | Data | Data |
| ±1% | 12.2% | 24.5% | 13.2% | 22.3% |
| ±2% | 19.4% | 46.7% | 21.2% | 45.6% |
| ±3% | 35.9% | 69.7% | 37.6% | 56.5% |
| ±4% | 51.5% | 96.2% | 53.9% | 63.6% |
| ±5% | 64.1% | 98.7% | 68.1% | 72.7% |
| ±6% | 75.2% | 99.9% | 77.3% | 81.3% |
| ±7% | 81.8% | 99.9% | 83.6% | 89.9% |
| ±8% | 84.3% | 99.9% | 86.7% | 93.4% |
| ±9% | 88.9% | 99.9% | 89.2% | 95.6% |
| ±10% | 90.7% | 99.9% | 92.2% | 97.1% |
| ±11~15% | 97.5% | 99.9% | 94.5% | 98.2% |
| ±16~20% | 98.8% | 99.9% | 95.2% | 99.1% |
| ±21~30% | 99.9% | 99.9% | 99.3% | 99.9% |

At 310, the statistical features generated at 308 are combined to generate a single combined set of statistical data. In at least some embodiments, the statistical features are combined by allocating pre-defined bias weights to each data category, in accordance with Equation (1):

Combined Statistical Data=[(Stat_{GAH})*W_{GAH}(Stat_{AHP})*W_{AHP}(Stat_{ARP})*W_{ARP}]*W_{Historical}+(Stat_{ED})*W_{ED} (1)

wherein Stat_{GAH} is a statistical feature generated using the global athlete historical (GAH) data, Stat_{AHP} is a statistical feature generated using the athlete historical performance (AHP) data, Stat_{ARP} is a statistical feature generated using the athlete recent performance (ARP) data, and Stat_{ED} is a statistical feature generated using the external data (ED). Further, W_{GAH} is a bias weight allocated for the GAH data, W_{AHP} is a bias weight allocated for the AHP data, W_{ARP} is a bias weight allocated for the ARP data, W_{Historical} is a bias weight for allocated all historical data (e.g., GAH, AHP, and ARP), and W_{ED} is bias weight allocated for the external data.

In at least one example embodiment, W_{GAH} may be initialized to “0.2”, W_{AHP} may be initialized to “0.5”, W_{ARP} may be initialized to “0.3”, W_{Historical} may be initialized to “0.5”, and W_{ED} may be initialized to “0.5”. As explained in further detail herein, the initial bias weightings may be modified in view of the actual performance outcome of the athlete, or sporting entity. It will also be appreciated that the statistical features, for each data category, may be combined in any other suitable manner.

Table 7, below, shows exemplary combined statistical data generated using Equation (1):

TABLE 7
Combined Statistical Data

| | Combined Statistical Data |
|---|---|
| Average Points Scored | 28.34 |
| Standard Deviation | 4.84 |
| Confidence Rating (Exact) | 10.95% |
| Confidence Rating (Ranges) | |
| ±1% | 18.574% |
| ±2% | 35.01% |
| ±3% | 50.428% |
| ±4% | 64.674% |
| ±5% | 74.248% |
| ±6% | 82.338% |
| ±7% | 88.514% |
| ±8% | 91.036% |
| ±9% | 93.596% |
| ±10% | 95.096% |
| ±11~15% | 97.825% |
| ±16~20% | 98.686% |
| ±21~30% | 99.828% |

In various cases, the average statistic (e.g., average points scored) may constitute a prediction for the target performance metric. For example, the results in Table 7 is used to predict that the athlete will score approximately 28 points in a forthcoming sporting event. Based on the exact confidence rating, there is approximately a 10.95% probability that the athlete will score 28 points in the forthcoming game. The confidence ranges in Table 7 can also be used to determine betting odds in a game of skill (e.g., contest) involving users placing bets on the expected performance of a sporting entity. For example, the probability that the athlete may score within one percent of the predicted score (e.g., the average score) may be determined to be 18.574%, in accordance with Table 7. Accordingly, appropriate betting odds may be generated based on this statistical basis.

At 312, the actual performance outcome is determined (e.g., actual number of points scored in the game by the target athlete). For example, the actual outcome may be determined using data that is pushed, or pulled, from one or more data providers 108 by RDAP 210. In at least some embodiments, the actual outcome may be determined after the sporting event is complete. In other embodiments, the actual performance outcome may be determined during an on-going or live game. For example, where the target performance metric relates to the performance of an athlete in an in-game event (e.g., the probability an athlete will score a free-throw during a basketball game), the actual outcome may be determined immediately after the in-game event is complete.

At 314, based on the actual outcome at 310, the accuracy of the performance prediction (e.g., the average statistic generated in Table 7) is determined. In some cases, based on the actual outcome, the bias weightings in Equation (1), may be modified to improve the predictive output of the SDG 212.

In at least some embodiments, the SDG 212 may use a machine learning algorithm to initialize, and re-adjust the bias weightings in Equation (1) based on the actual performance outcome. The machine learning algorithm may be configured for “supervised learning”, and may initialize the bias weights using a set of “training data” available, for example, in memory 206 of server 102. The “training data” may comprise previous performance data for a sporting entity.

Referring now back to FIG. 2A, the server 102 may also include a contest generator 214. Contest generator 214 may be configured to generate contests (or games) which allow one or more users (e.g., of user devices 106), to predict the expected performance outcome of a sporting entity. For instance, in various example cases, the contests may allow users to predict the total points a team or player will score in an upcoming event.

In various embodiments, contest generator 214 can generate live-contests for events occurring during a live sporting match. For instance, contest generator 214 can receive real-time, or near real-time, live event data for an on-going sporting event (e.g., via RDAP 210). Based on the live event data, the contest generator 214 can detect an in-game event and may be configured to generate a contest which allows users to predict the outcome of the in-game event. By way of example, the contest generator 214 can detect, from live data from a sports feed, that a basketball player is in the process of taking a free throw shot. Accordingly, the contest generator 214 may generate a live contest which allows users to predict, in real-time or near real-time, the outcome performance of the free throw shot.

In at least some embodiments, contest generator 214 can automatically generate a contest, or a set of contests, in anticipation of a sporting event. In particular, contest generator 214 can determine upcoming sporting events based on a schedule of sporting matches (e.g., stored on memory 208). Accordingly, before or during the sporting event, the contest generator 214 can generate specific contests for events that are expected to occur in the sporting match (for example, based on the nature of the sporting event). For instance, in a game of baseball, the contest generator 214 can pre-generate contests for predicting the performance of a batter, predicting whether a player will steal a base, or predicting the number of runs a team will score in a particular inning (e.g., events which are common and generic to all baseball games). The contests may then be activated during a live event when it is determined that the relevant in-game event is occurring based on a live data feed.

In other cases, contest generator 214 may receive instructions from an operator of administrator computer 104 to generate specific contests.

In at least one example application, contest generator 214 may generate contests that allow users to place predictive bets on the expected performance outcome of a sporting entity. In at least some embodiments, the betting odds may be determined based on the confidence ranges generated by the statistical data generator (SDG) 212. For example, the SDG 212 may receive instructions from the contest generator 214 to generate prediction outcomes, and confidence ranges, for a target performance metric, which is the subject of a contest. The contest generator 214 may then use the generated statistical data to generate a predicted outcome for the sporting event, and to further generate betting odds based on the confidence ranges. For instance, in reference to Table 7, the contest generator 214 may determine an 18.574% probability that a player will score 28 points in an upcoming sport match, and a 35% chance the player will score within 1% of the predicted points.

Contest entry aggregator (CEA) 216 may receive, via communication interface 206, one or more predictions (or bets) placed by users in respect of contests generated by contest generator 214. In at least some embodiments, the CEA 216 may also control, or otherwise determine, whether a contest is “open” for receiving entries, and whether the contest is otherwise “closed”. For instance, in cases where contests are generated for a live in-game sporting event, the CEA 216 may “open” a contest where it is determined that an in-game event is occurring (e.g., the CEA 216 may begin accepting contest entries from one or more users of user devices 106), and may “close” the contest once the in-game event is completed. The CEA 218 may determine whether a contest is closed based on event data received by the RDAP 210 from data providers.

Contest entry archiver (CEA) 218 may archive the contest entries received by the CEA 218, and in some cases, may also archive the outcome of the contest into memory 208 of server 102. In various cases, the CEA 218 may also time-stamp both the contest entries, as well as contest outcome. The time-stamped contest entries and outcome may be, in various cases, transmitted, via communication interface 206, to a third party insurance provider in the event that the results of a contest are disputed.

Result generator 220 is configured to also receive the contest entries and the actual performance outcome and may use this information to determine the winning contest entries. In cases where contests allow users to place predictive bets, the result generator 220 may also determine payouts for the betting contestants.

In at least some embodiments, where the contests are betting contests, payouts for betting contests may be determined according to a progressively escalating payout scheme. For example, the payout for a contest may vary based on the proximity of a contest entry to the actual performance outcome. Accordingly, higher payouts are awarded where predictions are more proximate to actual performance outcomes, and lower payouts are awarded where the predictions are farther from the actual outcome. This may be contrasted to conventional payout schemes, which only award payouts where a contestant correctly predicts the contest outcome. In particular, it has been appreciated that using a progressively escalating payout scheme—which does not rely on a conventional “all-or-nothing” payout—may provide for a more engaging user experience for users of the betting contest. In at least some embodiments, the amount of payout in the progressive payout scheme may be determined according to the confidence rating ranges generated by SDG 212 (e.g. betting odds). For example, based on how far the bet is from the predicted average score, the predicted bet may be correlated to a specific confidence range in order to determine the odds for making that prediction, and accordingly, the degree of payout.

In another embodiment, a contest may require users to predict a series of performance outcomes. For example, users may be asked to make six separate predictions for six different performance metrics. Accordingly, the payout may vary based on the number of correct predictions. For instance, users who correctly predicts five out of six performance outcomes may be awarded a greater pay-out than users who correctly predict one out of six outcomes. Accordingly, this embodiment of the progressively escalating payout scheme may allow for a more engaging user experience by also avoiding an “all-or-nothing” payout.

In at least some embodiments, the escalating payouts may also include a “perfect line bonus”. The “perfect line bonus” may be awarded, for example, where a user correctly predicts all performance outcomes in a contest which involves making a set or series of predictions (e.g., correctly predicting five out five predictions). In various cases, the “bonus line” may provide a greater than ordinary payout in order to reward contestants who correctly predict all performance outcomes.

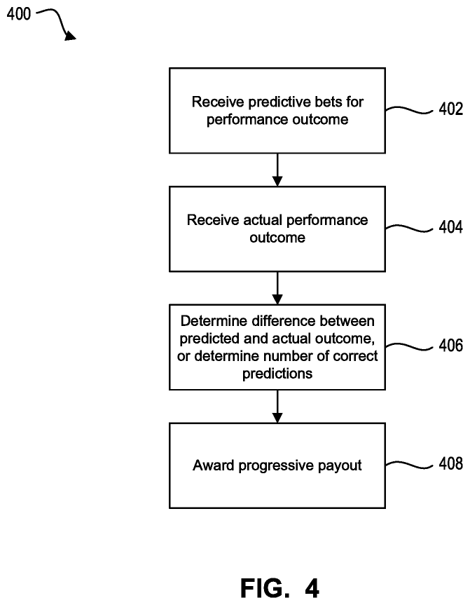

Referring now to FIG. 4, there is shown an example process flow for a method 400 for determining payouts in a betting contest according to a progressive escalating payout scheme. The method 400 may be implemented by the processor 202 of server 102.

At 402, predictive bets are received from one or more contestants (e.g., users of user devices 106) in respect of a contest generated by the contest generator 214. The predictive bets may be aggregated, for example, by the CEA 216.

At 404, the actual outcome of the contest is received by the RDAP 210 from a data provider 108 and accessed by the result generator 220.

At 406, the result generator 220 may determine the difference between the contestant's prediction and the actual outcome of the contest. In cases where the contest requires making a set of predictions (e.g., five predictions), the result generator 220 may also determine the number of correct predictions in the set of predictions.

At 408, a payout is determined according to a progressively escalating payout scheme. For example, for a single prediction, the result generator 220 may determine the payout based on the difference between the predicted outcome and the actual outcome. The payout in these cases can be determined based on the confidence ranges (e.g., Table 7). In other cases, the progressive payout is awarded based on the number of correct predictions in a set of predictions (e.g., four out of five correct predictions may be awarded a higher pay out than three out of four correct predictions). In still other cases, a “perfect line bonus” may be awarded where each prediction, in a set of predictions, is determined to be correct (e.g., five out of five correct predictions).

Referring now to FIG. 2B, there is shown a simplified block diagram of a user device 106, in accordance with an example embodiment.

User device 106 may be a non-mobile computer device, such as desktop computer mobile computer. As shown, user device 106 has a processor 222, a communication interface 224 for data communication, a display 226 for displaying a GUI, and a memory 230 that may include both volatile and non-volatile elements. As with server 105, references to acts or functions by mobile device 106 imply that processor 212 is executing computer-executable instructions (e.g., a software program) stored in memory 228.

The user device 106 also includes a client application 230. While the client application 230 is shown separately from memory 228, it will be understood that the client application 230 may be stored in memory 228. The user device 106 may also store a plurality of other software applications in memory 228. The device memory 228 may generally store instructions which, when executed by the device processor 222 causes, the device processor 222 to provide functionality of the various applications stored thereon.

In various embodiments, the client application 230 may be a standalone program (or software application) that is downloaded and installed on the user device 106 (e.g., through an app store such as the Apple App Store of Google Play).

In various embodiments, the client application 230 may be configured to allow a user, of user device 106, to participate in contests which are generated by the contest generator 214 of server 102. For example, in at least some embodiments, the client application 230 may receive contest information, via communication interface 224 of user device 106. The contest information may include the rules of the contest as well as the betting odds in the case of a betting contest. In various cases, the contest may be in respect of a future sporting event or a live sporting event (e.g., an in-game event). The client application 230 may also receive information as to whether the contest is “open” to receive contest entries, or is otherwise “closed” and completed. Where the contest is “open”, a user of user device 106 may enter a prediction outcome (e.g., a predictive bet), which may be transmitted back to the server 102 via network 110. For example, the user may enter predictive bets using a graphical user interface (GUI) of the display 226 of the user device 106. Once the contest is complete, a user of user device 106 may be notified in respect of whether their contest entry was correct, and whether the user received any payouts where the contest was a betting contest.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A system for generating statistical predictions for an expected performance of a sporting entity, the system comprising:
at least one server comprising at least one processor and a non-transitory memory having stored thereon instructions that, upon execution, cause the processor to perform functions comprising:
determining a target performance metric in association with the sporting entity;
determining at least one data category and at least one data filter in association with each of the at least one data category;
receiving data for each of the at least one data category, wherein the data received for each of the at least one data category is filtered according to the at least one data filter;
based on the received data, generating at least one statistical feature for each of the at least one data category, wherein the at least one statistical feature comprises a prediction of the expected performance of the sporting entity in respect of the target performance metric; and
updating the non-transitory memory to include the at least one statistical feature for each of the at least one data category.

2. The system of claim 1, wherein the data filters comprise at least one of a time interval filter and at least one key performance indicator (KPI) filter.

3. The system of claim 1, wherein the at least one data category comprises a plurality of data categories, wherein each of the plurality of data categories is assigned a respective bias weight, and the processor further preforms the function of:
generating a combined statistical data set by combining the at least one statistical feature generated for each of the plurality of data categories in accordance with the bias weights assigned to each of the plurality of data categories.

4. The system of claim 3, wherein the combined statistical data set comprises at least one of an average statistical value, a standard deviation, and a set of confidence rating ranges.

5. The system of claim 4, wherein the processor further preforms the function of:
receiving an actual performance outcome for the target performance metric;
based on the actual performance outcome, determining the accuracy of the combined statistical data set; and
based on the determined accuracy of the combined statistical data set, modifying the bias weightings assigned to each of the plurality of data categories.

6. The system of claim 5, wherein the system further preforms the function of:
generating a contest for predicting the actual performance outcome; and
generating a predicted outcome based on the average statistical value determined in the combined statistical data set.

7. The system of claim 6, wherein the contest is a betting contest and a set of betting odds are generated based on the set of confidence rating ranges in the combined statistical data set.

8. The system of claim 7, wherein the processor further preforms the function of:
receiving at least one contest entry from at least one contestant, wherein each of the at least one contest entry comprises a predicted outcome for the contest;
determining the difference between the actual performance outcome and the predicted outcome, for each of the at least one contest entry; and
based on the difference, determining a payout, wherein the payout increases as the predicted outcome is more proximal to the actual performance outcome, and wherein the value of the payout is determined according to the set of betting odds.

9. The system of claim 6, wherein the contest comprises predicting a plurality of target performance metrics for at least one sporting entity, and the processor further preforms the function of:
receiving at least one contest entry from at least one contestant, wherein each of the at least one contest entry comprises a set of predicted outcomes for the contest;
based on the actual performance outcome, determining the number of correct predictions in the set of predicted outcomes for each of the at least one contest entry; and
determining a payout for each of the at least one contestant, wherein the payout increases in proportion to the number of correct predictions in the set of predicted outcomes, and wherein the value of the payout is determined according to the set of betting odds.

10. The system of claim 9, wherein a bonus line is awarded as a payout in a case where each prediction, in the set of predicted outcomes, is correct.

11. A method for generating statistical predictions for an expected performance of a sporting entity, the method being implemented by at least one server comprising least one processor and a non-transitory memory, the method comprising:
determining a target performance metric in association with the sporting entity;
determining at least one data category, and at least one data filter in association with each of the at least one data category;
receiving data for each of the at least one data category, wherein the data received for each of the at least one data category is filtered according to the at least one data filter;
based on the received data, generating at least one statistical feature for each of the at least one data category, wherein the at least one statistical feature comprises a prediction of the expected performance of the sporting entity in respect of the target performance metric; and
updating the non-transitory memory to include the at least one statistical feature for the at least one data category.

12. The method of claim 11, wherein the data filters comprise at least one of a time interval filter and at least one key performance indicator (KPI) filter.

13. The method of claim 12, wherein the at least one data category comprises a plurality of data categories, wherein each of the plurality of data categories is assigned a respective bias weight, and the method further comprises:
generating a combined statistical data set by combining the at least one statistical feature generated for each of the plurality of data categories in accordance with the bias weights assigned to each of the plurality of data categories.

14. The method of claim 13, wherein the combined statistical data comprises at least one of an average statistical value, a standard deviation, and a set of confidence rating ranges.

15. The method of claim 14, further comprising:
receiving an actual performance outcome for the target performance metric;
based on the actual performance outcome, determining the accuracy of the combined statistical data set; and
based on the determined accuracy of the combined statistical data set, modifying the bias weightings assigned to each of the plurality of data categories.

16. The method of claim 15, further comprising:
generating a contest for predicting the actual performance outcome; and
generating a predicted outcome based on the average statistical value determined in the combined statistical data set.

17. The method of claim 16, wherein the contest is a betting contest and a set of betting odds are generated based on the set of confidence rating ranges in the combined statistical data set.

18. The method of claim 17, further comprising:
receiving at least one contest entry from at least one contestant, wherein each of the at least one contest entry comprises a predicted outcome for the contest;
determining the difference between the actual performance outcome and the predicted outcome, for each of the at least one contest entry; and
based on the difference, determining a payout, wherein the payout increases as the predicted outcome is more proximal to the actual performance outcome, and wherein the value of the payout is determined according to the set of betting odds.

19. The method of claim 18, wherein the contest comprises predicting a plurality of target performance metrics for at least one sporting entity, and the method further comprises:
receiving at least one contest entry from at least one contestant, wherein each of the at least one contest entry comprises a set of predicted outcomes for the contest;
based on the actual performance outcome, determining the number of correct predictions in the set of predicted outcomes, for each of the at least one contest entry; and
determining a payout for each of the at least one contestant, wherein the payout increases in proportion to the number of correct predictions in the set of predicted outcomes, and wherein the value of the payout is determined according to the set of betting odds.

20. The method of claim 19, wherein a bonus line is awarded as a payout where each prediction in the set of predicted outcomes is correct.
